(19) United States
(12) Patent Application Publication
(10) Pub. No.: US 2020/0012119 A1
(43) Pub. Date: Jan. 9, 2020

(54) REDUCING GLARE FOR OBJECTS VIEWED THROUGH TRANSPARENT SURFACES

(71) Applicant: Polaris Sensor Technologies, Inc., Huntsville, AL (US)

(72) Inventors: J. Larry Pezzaniti, Huntsville, AL (US); David B. Chenault, Huntsville, AL (US)

(21) Appl. No.: 16/505,241

(22) Filed: Jul. 8, 2019

Related U.S. Application Data
(60) Provisional application No. 62/694,586, filed on Jul. 6, 2018.

(51) Int. Cl. G02B 27/28; G06K 9/00; G06T 5/00; G02B 5/20

(52) U.S. Cl. CPC G02B 27/286; G06K 9/00234; B60J 1/02; G02B 5/201; G06T 5/003

(57) ABSTRACT

In a method of detecting objects behind substantially transparent surfaces, a polarimeter with pixelated polarizer array architecture records raw image data of a surface and obtains polarized images. Glare is reduced in the polarized images to form enhanced contrast images. The glare reduction method selects optimal pixels from a subset of a super pixels of polarizing filters and displays the optimal pixels.

### REFERENCE TO RELATED APPLICATIONS

This application claims priority to U.S. Provisional Patent Application Ser. No. 62/694,586, entitled “Method for Improved Viewing through Transparent Surfaces” and filed on Jul. 6, 2018, which is fully incorporated herein by reference.

### BACKGROUND AND SUMMARY

A method using imaging polarimetry for the detection of objects behind transparent surfaces is disclosed herein. The described method is not tied to any one specific portion or subset of the optical spectrum and thus the method described pertains to all sensors that operate in the optical spectrum. The sensor must be able to see through the surface so spectral limitations are given by the transmission/transparency of the surface. The method comprises reducing the glare off of the transparent surface through polarization filtering through the use of a pixelated polarizer AKA division of focal plane polarimeter. This is done in order to select the best angles over which the glare reduction will be most effective. The advantage of using this method is that the glare reduction is immune to changes in angle between the source of glare, the camera, and the surface. The polarimeter is mounted on a platform such that the sensor points towards the surface within the range of the acceptable angles. The sensor is then used to transmit raw image data of an area using polarization filtering to obtain polarized images of the area. The images are then corrected for non-uniformity, optical distortion, and registration in accordance with the procedure necessitated by the sensor's architecture. The optimal pixel within each set of pixels in a super pixel of the division of focal plane polarimeter is chosen to minimize glare. Optionally, the optimal angle of polarization that reduces glare is computed from for each super pixel of the polarimeter and used to compute the glare reduced image as a weighted sum of intensities from each super-pixel, as described in Equations 1-7 below.

### DESCRIPTION OF THE DRAWINGS

The patent or application file contains at least one drawing executed in color. Copies of this patent or patent application publication with color drawings will be provided by the Office upon request and payment of the necessary fee.

FIG. 1 depicts a system for viewing objects and persons through a windshield of an automobile, according to an exemplary embodiment of the present disclosure.

FIG. 2 depicts an exemplary system comprised of a polarimeter and signal processing unit according to an embodiment of the present disclosure.

FIG. 3 is an embodiment of a PPA as a wire grid type polarizer with a plurality of pixels.

FIG. 4 is a graph of exemplary s- and p-reflectance vs. ray angle of incidence for common glass with refractive index of n=1.6.

FIG. 5 depicts a PPA with pixels polarized at −20, −10, 0, 10, and 20°.

FIG. 6 depicts a method for detecting objects behind transparent surfaces according to an exemplary embodiment of the present disclosure.

FIG. 7 depicts a method for applying contrast enhancement algorithms according to an exemplary embodiment of the present disclosure.

FIG. 8 is an so image of an occupant seen through a windshield of an automobile.

FIG. 9 is a DoLP image of the same occupant as in FIG. 8 seen through the same windshield as in FIG. 8.

FIG. 10 is a horizontal polarization image of the same occupant as in FIG. 8 seen through the same windshield as in FIG. 8.

FIG. 11 is a vertical polarization image of the same occupant as in FIG. 8 seen through the same windshield as in FIG. 8.

FIG. 12 is a “minimum pixel” image of the automobile and occupant of FIG. 8 that displays the pixels with the lowest counts from each super-pixel.

FIG. 13 depicts two automobiles being imaged by two polarimeters at different angles, and illustrates why multiple polarization angles are required.

### DETAILED DESCRIPTION

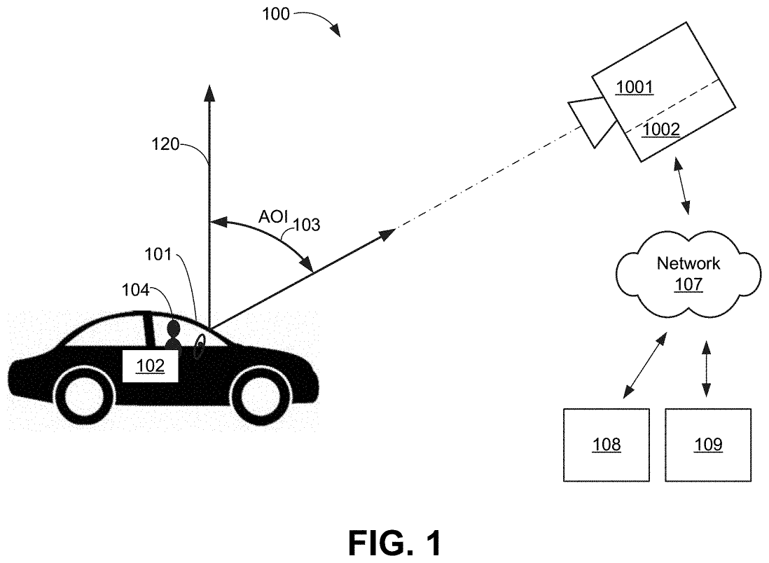

FIG. 1 illustrates a system 100 in accordance with an exemplary embodiment of the present disclosure. The system 100 comprises a polarimeter 1001 and a signal processing unit 1002, which collect and analyze images through a generally transparent surface 101, which in the illustrated embodiment is the windshield of an automobile 102. The system 100 may be used to generate images of an occupant 104 or objects(s) within the automobile.

The system 100 comprises a polarimeter 1001 for recording polarized images, such as a digital camera or IR imager that collects images. The polarimeter 1001 may be mounted on a tower or platform (not shown) such that it views the surface 101 at an angle 103 from a vertical direction 120. The angle 103 is the angle of incidence.

The polarimeter 1001 transmits raw image data to the signal processing unit 1002, which processes the data as further discussed herein. The processed data is then displayed via a display 108. Alternatively, detection is annunciated on an annunciator 109, as further discussed herein. Although FIG. 1 shows the polarimeter 1001 and the signal processing unit 1002 as a combined unit, in certain embodiments the polarimeter 1001 and signal processing unit 1002 are separate units. For example, the polarimeter 1001 may be mounted remotely on a platform or tower (not shown) and the signal processing unit 1002 placed close to the operator. Similarly, the display 108 or annunciator 109 can be packaged with the system 100 or packaged with the signal processing unit 1002 or be separate from all other components and each other.

In the illustrated embodiment, the polarimeter 1001 sends raw image data (not shown) to the signal processing unit 1002 over a network or communication channel 107 and processed data sent to the display 108 and annunciator 109. The signal processing unit 1002 receives the raw image data, filters the data, and analyzes the data as discussed further herein to provide enhanced imagery and detections and annunciations. The network 107 may be of any type network or networks known in the art or future-developed, such as a simple communications cable, the internet backbone, Ethernet, Wifi, WiMax, wireless communications, broadband over power line, coaxial cable, and the like. The network 107 may be any combination of hardware, software, or both. Further, the network 107 could be resident in a sensor (not shown) housing both the polarimeter 1001 and the signal processing unit 1002.

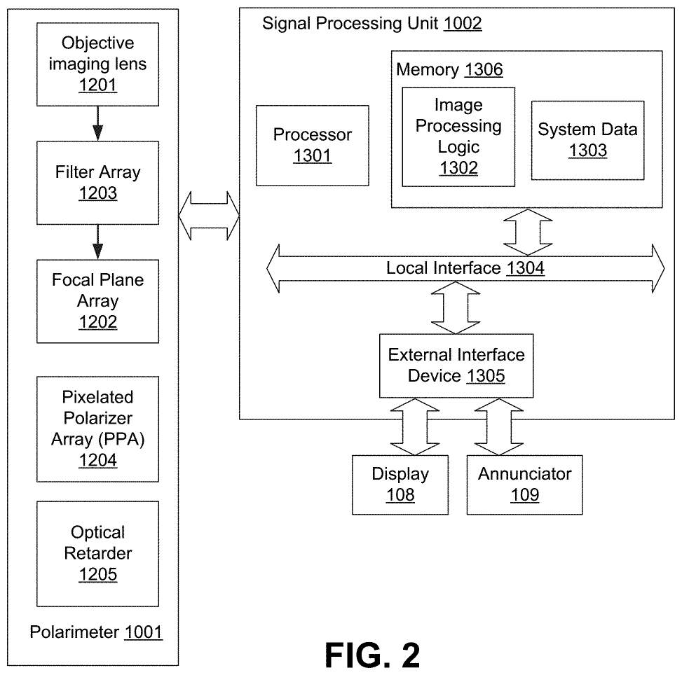

FIG. 2 depicts an exemplary system 100 comprised of a polarimeter 1001 and signal processing unit 1002 according to an embodiment of the present disclosure. The polarimeter 1001 comprises an objective imaging lens 1201, a filter array 1203, and a focal plane array 1202. The objective imaging lens 1201 comprises a lens pointed at the surface 101 and 102 (FIG. 1). The filter array 1203 filters the images received from the objective imaging lens system 1201. The focal plane array 1202 comprises an array of light sensing pixels.

The polarimeter 1001 also comprises a pixelated polarizer array (“PPA”) 1204, which comprises pixels that are aligned to and brought into close proximity with pixels of the focal plane array 1202. The polarimeter may optionally comprise an optical retarder 1205, as further discussed herein.

The signal processing unit 1002 comprises image processing logic 1302 and system data 1303. In the exemplary signal processing unit 1002 image processing logic 1302 and system data 1303 are shown as stored in memory 1306. The image processing logic 1302 and system data 1303 may be implemented in hardware, software, or a combination of hardware and software.

The signal processing unit 1002 also comprises a processor 1301, which comprises a digital processor or other type of circuitry configured to run the image processing logic 1302 by processing the image processing logic 1302, as applicable. The processor 1301 communicates to and drives the other elements within the signal processing unit 1002 via a local interface 1304, which can include one or more buses. When stored in memory 1306, the image processing logic 1302 and the system data 1303 can be stored and transported on any computer-readable medium for use by or in connection with logic circuitry, a processor, an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

An external interface device 1305 connects to and communicates with the display 108 and annunciator 109. The external interface device 1305 may also communicate with or comprise an input device, for example, a keyboard, a switch, a mouse, a touchscreen, and/or other type of interface, which can be used to input data from a user of the system 100. The external interface device 1305 may also or alternatively communicate with or comprise a personal digital assistant (PDA), computer tablet device, laptop, portable or non-portable computer, cellular or mobile phone, or the like. The external interface device 1305 may also or alternatively communicate with or comprise a non-personal computer, e.g., a server, embedded computer, field programmable gate array (FPGA), microprocessor, or the like.

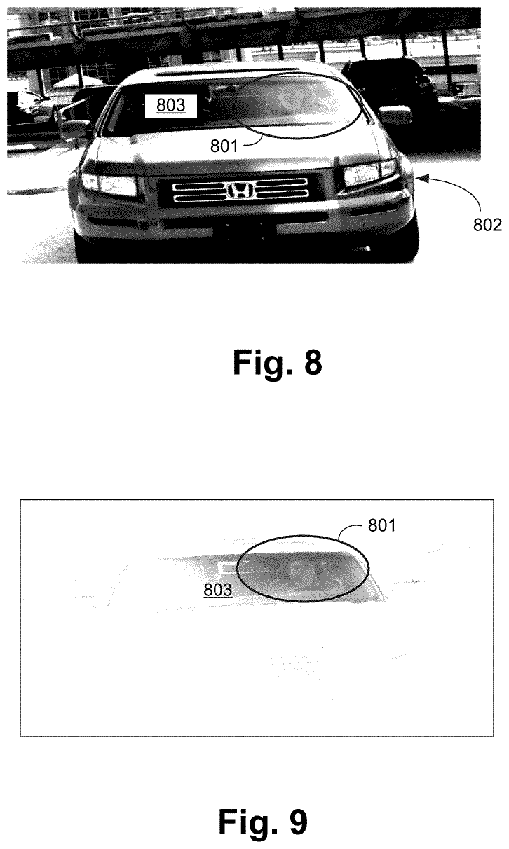

The external interface device 1305 is shown as part of the signal processing unit 1002 in the exemplary embodiment of FIG. 8. In other embodiments, the external interface device 1305 may be outside of the signal processing unit 1002.

The display device 108 may consist of a TV, LCD screen, monitor or any electronic device that conveys image data resulting from the method 900 or is attached to a personal digital assistant (PDA), computer tablet device, laptop, portable or non-portable computer, cellular or mobile phone, or the like. The annunciator device 109 can consist of a warning buzzer, bell, flashing light, or any other auditory or visual or tactile means to alert the operator of the detection or identification of a person or object behind the surface, e.g, behind the windshield of the car. In some embodiments, the annunciator may be used in conjunction with facial recognition software and would alert an operator to the detection of a specific person. In other embodiments, the annunciator may be used to alert an operator to the detection of any person, e.g., detect that a vehicle is occupied.

In the illustrated embodiment, the display 108 and annunciator 109 are shown as separate, but the annunciator 109 may be combined with the display 108, and in another embodiments, annunciation could take the form of highlighted boxes or regions, colored regions, or another means used to highlight the object as part of the image data display. Other embodiments may not include an annunciator 109.

The imaging polarimeter 1001 comprises the PPA 1204, which comprises pixels that are aligned to and brought into close proximity to the pixels of the focal plane array (FPA), such that interlaced images of different polarization states are collected in a single image and used to compute polarized images of the scene. The imaging sensor comprising a PPA mounted to an FPA is also called a division of focal plane polarimeter with operation analogous to that of the Bayer RGB pattern mounted on a CCD or CMOS focal plane array for color imaging. CCD or CMOS FPAs are typical for use in the visible part of the spectrum and are robust and with mature readout and signal processing electronics. Various formulations of CCD or CMOS arrays may cover sub regions of this spectral band, for example one common spectral band is 400 to 700 mm Other detector types such as InGaAs for the short wave infrared may also be used. The surface 101 (FIG. 1) needs to be substantially transparent in the operating part of the spectrum.

A wire grid type polarizer is a desirable structure for the PPA because, among other reasons, a wire grid type polarizer has a wide angular acceptance cone and operates over a wide spectral bandwidth. The wide acceptance cone is important because the polarizer is positioned at the focal plane of the image the light is coming to focus. This allows the optical system to operate with a “fast” lens or in other words with a low f-number lens. For an f/l (f-number) lens, the ray cone incident on the PPA has approximately a 30 degree half angle. The transmission properties and polarization rejection of the wire grid polarizer is optimal up to angles exceeding 30 degrees. Another advantage of the wire grid polarizer is that it can operate over wide spectral bandwidths. This also is well within the capabilities of a wire grid polarizer design.

Other formulations of pixelated polarizer arrays are possible in other embodiments. For example, in lieu of the wire grid type polarizer, polarizers having microcomponents which preferentially absorb or reflect energy in one state and transmit the energy in a second state can be employed. Such polarizers could include any set of microstructures created by polymers or other nanomaterials.

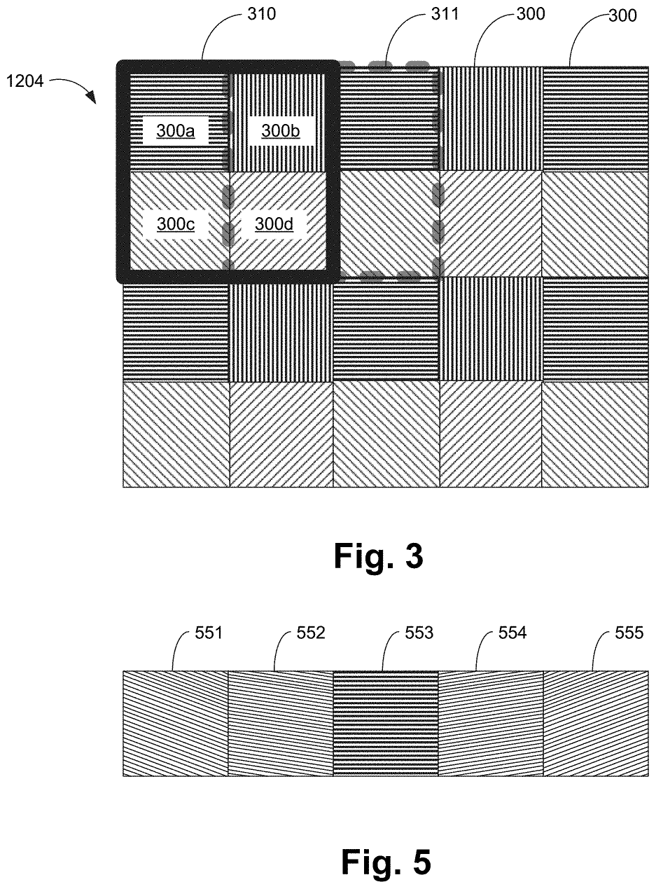

FIG. 3 is an embodiment of the PPA 1204 as a wire grid type polarizer with a plurality of pixels 300, each PPA pixel 300 has a polarizer with its transmission axis oriented at a particular angle, preferably 0, 45, 90 and 135 degrees. For example, pixel 300a has a polarizer oriented at 0 degrees; pixel 300b has a polarizer oriented at 90 degrees; pixel 300c has a polarizer oriented at 135 degrees; and pixel 300d has a polarizer oriented at 45 degrees. Pixels 300a-300d form a 2×2 array 310, or “super pixel.” In one embodiment the pixels are 2 microns×2 microns square.

In the wire grid polarizer, the polarization transmission axis is orthogonal to the long axis of the wires. Radiation that is polarized with its electric field parallel to the plane parallel to the wires is absorbed and radiation polarized perpendicular to the wires is transmitted. The efficiency of the polarizer is defined as how efficiently it transmits the desired polarization state and the extent to which it extinguishes the undesired (orthogonal) polarization state. Several parameters of the wire grid polarizer determine the efficiency of the polarizer. These parameters include the period of the wire grid (spacing between neighboring wires), the duty cycle of the wire grid (ratio of wire width to spacing between wires), the thickness of the wires, the material of the wire, the substrate refractive index, and the prescription of the AR coating upon which the wires are deposited. Note that unless the wires are deposited on a very low refractive index substrate, it is important that the substrate be AR coated to maximize transmission of the desired polarization state. Also the wires can be deposited on top of the AR coating or in any of the layers of the AR coating. The optimal choice for which layer to deposit the wires depends on the waveband (wavelength) of operation the range of angles of incidence that the polarizer must operate, the substrate that is used for the polarizer and the properties of the wire grid (pitch, duty cycle, wire material, wire thickness). In one embodiment, the pitch of the PPA is chosen to exactly match the pitch of the FPA. The wire grid polarizer can be designed using Rigorous Coupled Wave Analysis (RCWA) code (such as G-solver commercial RCWA code), or Finite Element Methods (such as Ansoft HFSS modeling code). This latter software utilizes the finite-element-method (FEM) to solve the electromagnetic fields that propagate through and scatter from the wire grid polarizer elements.

The fraction of light reflected from a transparent surface is dependent on the light ray's angle and its polarization state. The plane of incidence is defined to be the plane containing the normal of the transparent surface and the light ray. If the light ray is polarized in a linear direction perpendicular to the plane of incidence, it is said to be s-polarized. If the light ray is polarized in the plane of incidence, it is said to be p-polarized.

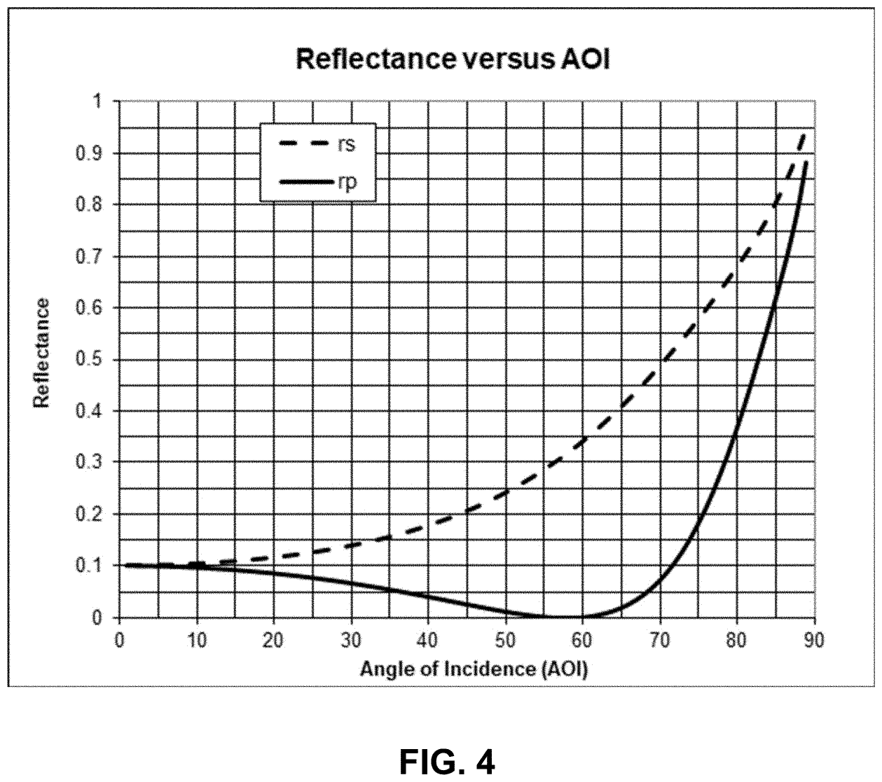

FIG. 4 is a graph of exemplary s- and p-reflectance vs. ray angle of incidence for common glass with refractive index of n=1.6. The angle of incidence is defined to be the angle between the normal to the transparent surface and the light ray. At 0 degrees angle of incidence the light ray is parallel to the surface normal, and 90 degrees angle of incidence is grazing incidence on the surface. The reflectance for the s-polarized state is always higher than the p-state. Rays polarized in the s-polarization state are primarily responsible for glare. Polarized sun-glasses used by fishermen to reduce glare from the water are designed to pass p-polarized light and absorb s-polarized light.

The pixels of the PPA and the pixels of the focal plane array are aligned in a one to one fashion so that the pixels of the PPA and the pixels of the focal plane array are all aligned to one another.

In one embodiment of the system, the pixel from a polarimetric 2×2 super-pixel of the polarimeter that reports the lowest value can be selected as the object point's pixel. In this way, the light reflected from the windshield is approximately minimized by choosing the component of polarization that is most orthogonal to the s-state reflected from the transparent glass.

For curved transparent surfaces such as a car windshield, the plane of incidence with respect to the viewer varies across the curved windshield. If the downwelling light reflected from the transparent surface is unpolarized, the Stokes vector of a light ray reflected from the transparent surface is given by

$$\vec{S} = [ \begin{matrix}1 & 0 & 0 \\ 0 & cos 2 ϕ & sin 2 ϕ \\ 0 & - sin 2 ϕ & cos 2 ϕ\end{matrix} ] [ \begin{matrix}{r}_{s} + {r}_{p} \\ {r}_{s} - {r}_{p} \\ 0\end{matrix} ] \cdot {s}_{0} \qquad ( 1 )$$

where rₛ is the reflectance of the s-polarization state, rₚ is the reflectance of the p-polarization state, s₀ is the intensity of the light ray incident on the surface, and φ is the orientation of the plane of incidence relative to the viewer.

From Equation (1), the Stokes vector reflected from the transparent windshield is given by

$$\vec{S} = [ \begin{matrix}{s}_{0} \\ {s}_{1} \\ {s}_{2}\end{matrix} ] = [ \begin{matrix}{r}_{s} + {r}_{p} \\ ( {r}_{s} - {r}_{p} ) cos 2 ϕ \\ - ( {r}_{s} - {r}_{p} ) sin 2 ϕ\end{matrix} ] \qquad ( 2 )$$

A polarimeter is ideally suited to reject the s-polarized component reflected from a transparent surface by multiplying the Stokes vector reported by the polarization analyzer vector [1−cos 2φ sin 2φ] to obtain the intensity I_{w} with most of the glare removed,

$${I}_{w} = \frac{1}{2} \cdot [ 1 - cos 2 ϕ sin 2 ϕ ] \cdot [ \begin{matrix}{r}_{s} + {r}_{p} \\ ( {r}_{s} - {r}_{p} ) cos 2 ϕ \\ - ( {r}_{s} - {r}_{p} ) sin 2 ϕ\end{matrix} ] \cdot {s}_{0} = \frac{1}{2} [ ( {r}_{s} + {r}_{p} ) - ( {r}_{s} - {r}_{p} ) ] \cdot {s}_{0} \qquad ( 3 )$$

which simplifies to

l_{w}=rₚ·s₀ (4)

thus, minimizing the amount of light reflected from the transparent surface (glare) so that objects behind that transparent surface may be seen.

The orientation of the plane of incidence φ, is determined by

φ=½·arctan(s₂,s₁) (5)

Where arctan considers the sign of s₁ and s₂ so that the angle quadrant for co is determined. So, from equation (3) the intensity with glare removed l_{w} given a Stokes vector [s₀ s₁ s₂]^{T} is given by

l_{w}=½(s₀−s₁·cos 2φ+s₂·sin 2φ) (6)

Equation 6 can be written in terms of the individual intensities measured by the polarimeter pixels with a super pixel. For the case of a polarimeter with polarized pixels at orientations 0°, 45°, 90°, and 135°, Equation 6 becomes:

I_{w}+ξ₀·I₀+ξ₄₅·I₄₅+ξ₉₀·I₉₀+ξ₁₃₅·I₁₃₅ (7)

where I₀, I₄₅, I₉₀, and I₁₃₅ are the intensities reported by the 2×2 array of pixels in a single super-pixel, and ξ₀; ξ₄₅; ξ₉₀; and ξ₁₃₅ are weighting factors given by

ξ₀=½−cos 2ϕ, ξ₄₅=½+sin 2ϕ, ξ₉₀=½+cos 2ϕ, and ξ₁₃₅=½−sin 2ϕ (8)

Thus, the optimal image for visualizing an object behind a transparent surface is a weighted sum of the intensities recorded by the pixels within a super pixel. There may be situations where weighting factors that are different from the values calculated from Equation 8 to allow to optimize for lighting variations or non-ideal camera responses. A host of image processing algorithms that are familiar to those trained in the art may be applied to determine other weighting factors that optimize the contrast of objects behind the transparent surface.

Alternatively, the pixel from a polarimetric 2×2 super-pixel of the polarimeter that reports the lowest value can be selected as the object point's pixel. In this way, the light reflected from the windshield is approximately minimized by choosing the component of polarization that is most orthogonal to the s-state reflected from the transparent glass.

If the sky downwelling polarization is polarized, then equation (1) becomes

$$\vec{S} = [ \begin{matrix}1 & 0 & 0 \\ 0 & cos 2 ϕ & sin 2 ϕ \\ 0 & - sin 2 ϕ & cos 2 ϕ\end{matrix} ] [ \begin{matrix}{r}_{s} \cdot {L}_{s} + {r}_{p} \cdot {L}_{p} \\ {r}_{s} \cdot {L}_{s} - {r}_{p} \cdot {L}_{p} \\ 0\end{matrix} ] \qquad ( 7 )$$

where Lₛ is the radiant flux polarized in the s-plane of polarization, and Lₚ is the radiant flux polarized in the p-state of polarization, and Lₛ≠Lₚ. Equations 5 and 6 can still be applied and will still be effective in removing glare, because the polarization state orientation with the most reflection (the glare) will still be oriented in the φ direction.

If the s-state polarization orientations are known to vary between a range of angles, the PPA could have other orientations of wire grid polarizers in order to optimize glare reduction by rejecting the s-polarization state. For example, if the s-state orientations are known to vary between 70 and 110 degrees, one could use −20, −10, 0, 10, and 20° orientations in order to maximize glare at many common angles. FIG. 5 depicts a PPA with pixels 551, 552, 553, 554, and 555 polarized at −20, −10, 0, 10, and 20° respectively.

The pixels of the PPA and the pixels of the focal plane array are aligned in a one to one fashion so that the pixels of the PPA and the pixels of the focal plane array are all aligned to one another. In some embodiments, the PPA is fabricated directly on the pixels of the FPA.

The PPA can be any number of orientations. The PPA described here is in a 2×2 described here but could be 1×2, 1×3, 2×3, 3×3, etc.)

A retarder 1205 (FIG. 2), such as a half wave retarder, can be introduced in the optical train in order to bias the array of wire grid polarizers just described for the specific camera installation and a common orientation of transparent surfaces. The retarder could be optimized while being installed and then locked down for the permanent installation. If the camera angle changes, the retarder could be unlocked, adjusted, and locked again for the new angles. An algorithm to dynamically position the retarder used to adjust for the new angles can be based on the polarimetric data products. For example, the output of the polarimeter could be used to determine the average orientation of polarization emanating from the transparent surface. That angle could be used to calculate the orientation of the retarder that would cause the orientation of polarization emanating from the transparent surface to be blocked by one pixel in the super-pixel. Alternatively, the retarder could be continuously, or step-wise rotated and multiple images could be captured and compared visually or analytically to obtain an image with an optimal view of objects behind the transparent surface.

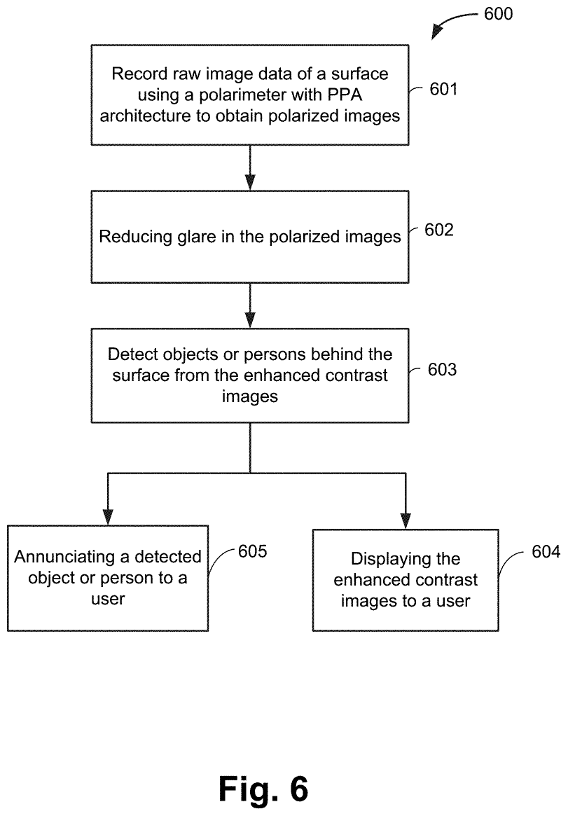

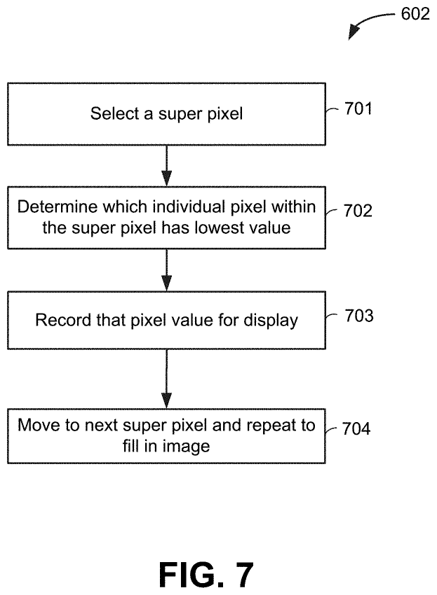

FIG. 6 depicts a method for detecting objects behind transparent surfaces according to an exemplary embodiment of the present disclosure. In step 601, a polarimeter with a PPA architecture as described herein records raw image data of a surface to obtain polarized images. In step 602, glare is reduced in the polarized images to form enhanced contrast images. Step 602 is described in more detail in FIG. 7 and the associated discussion.

In step 603, the signal processing unit detects objects or individuals behind the surface from the enhanced contrast images. In step 604, the enhanced contrast images are displayed to a user. In step 605, a detected object or individual is annunciated to a user.

FIG. 7 depicts a method for applying contrast enhancement algorithms (step 603 in FIG. 6) according to an exemplary embodiment of the present disclosure. In step 701, a super pixel (310 in FIG. 3) is selected in the signal processing unit. In step 702, the signal processing unit determines which individual pixel within the super pixel has the lowest value. In this way, the light reflected from the windshield is approximately minimized by choosing the component of polarization that is most orthogonal to the s-state reflected from the transparent glass. In step 703, that pixel value is recorded for display. In step 704, the signal processing unit moves to the next super pixel (311 in FIG. 3, shown in dashed lines), and repeats the selection process. This process continues until all of the super pixels in a region of interest have been selected, and pixels chosen for display.

FIG. 8 is an so image of an occupant 801 seen through a windshield 803 of an automobile 802. The occupant 801 is largely obscured by the glare reflected off the windshield 803.

FIG. 9 is a DoLP image of the same occupant 801 seen through the same windshield 803. Contrast of the occupant 801 is improved and glare off the windshield 803 is reduced by using the DoLP.

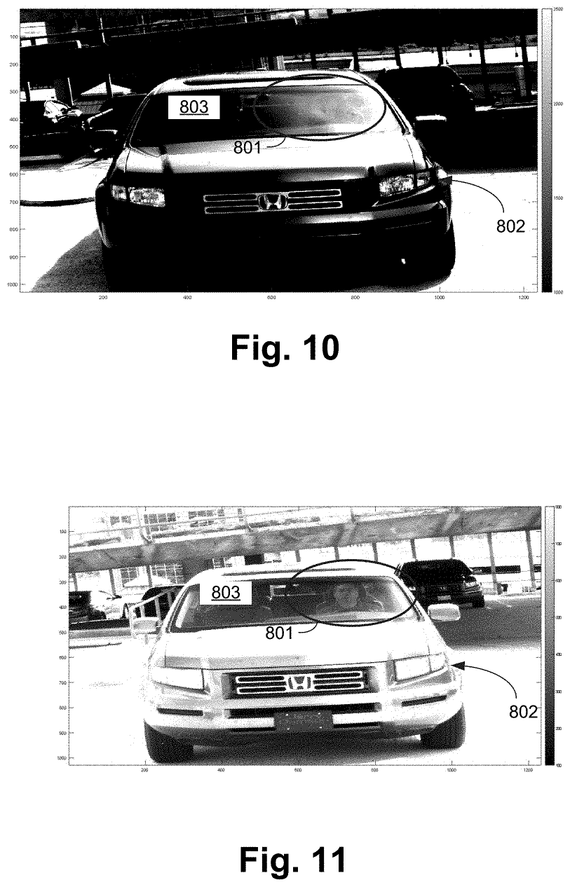

FIG. 10 is a horizontal polarization image of the same occupant 801 seen through the same windshield 803. In this case, the plane of incidence is vertical over most of the windshield 803 and hence the glare is horizontally polarized. The horizontal polarization image transmits the glare off the windshield 803 and obscures the occupant 801.

FIG. 11 is a vertical polarization image of the same occupant 801 seen through the same windshield 803. Again, the plane of incidence is vertical over most of the windshield 803 and hence the glare is horizontally polarized. The vertical polarization image rejects the glare off the windshield 803 and makes the occupant 801 clearly defined.

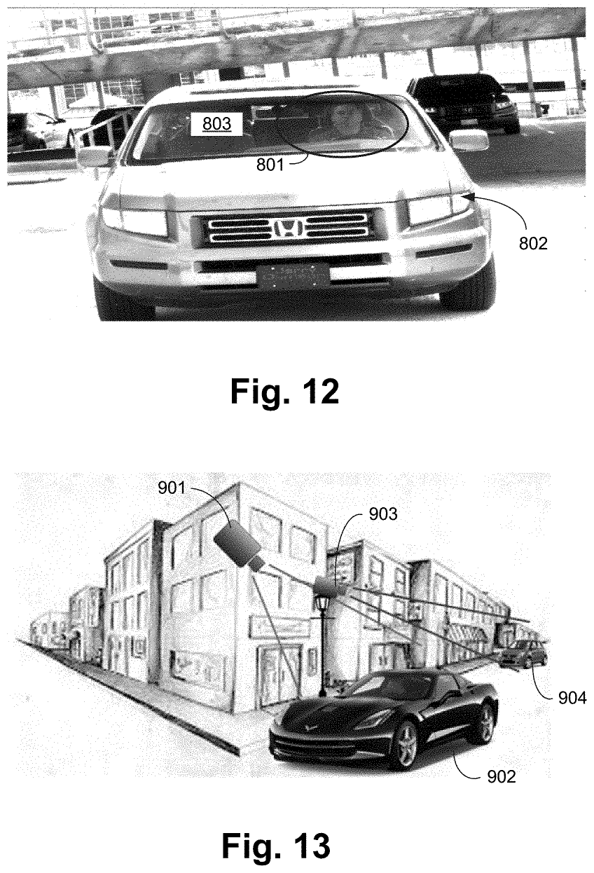

FIG. 12 is a “minimum pixel” image of the same occupant 801 seen through the same windshield 803. The minimum pixel image displays the pixels with the lowest counts from each super-pixel, i.e., the state that is most orthogonal to the s-polarization state. Because this image is generated by selecting the optimal pixels from each super pixel, this image is the most clearly defined.

FIG. 13 depicts two automobiles being imaged by two polarimeters at different angles, and illustrates why multiple polarization angles are required. The angle between the polarimeter 901 and windshield of automobile 902 is different from the angle between the polarimeter 903 and the windshield of automobile 904. Optimizing the polarization angle is needed to account for the different orientations between the camera and the automobile.

In other embodiments, the polarimeter could be part of a larger system that includes wifi or other connectivity to a control room, surveillance system, facial recognition system, or law enforcement for speeding tickets (to provide evidentiary level imagery for tickets and fines) and the like.

The method disclosed herein can be adapted for seeing through other transparent surfaces such as building windows, water on a water way, or others.

The imaging polarimeter as described herein may be used with ambient lighting from the sun and/or sky downwelling illumination or from an external man-made source such as a laser or other illumination that can be directed at the transparent surface. The external source can be used in day or night. If used in the daytime, the relative brightness of the external light source and natural lighting as measured by the polarimeter can be controlled by controlling the brightness of the external source and controlling wavelength response of the polarimeter. For example, if the illumination by the external source is required, then a wavelength selective filter can be used on the polarimeter to accept the light from the external source and reject the natural light.

The polarization state of the external source may also be controlled to minimize the amount of light reflected from the transparent surface. If the source is collocated with the camera, then most of the light will be reflected away from the camera unless the light is normally incident on the transparent surface. Nevertheless, some of the light from the reflected surface may be back-reflected toward the camera if it is not a specular surface. In this case the polarization of the source can be chosen to minimize back-reflection. Alternatively, the source may be made unpolarized or circularly polarized and the light reflected from the transparent surface may be minimized by the polarimeter as described herein.

What is claimed is:

1. A method of detecting objects behind substantially transparent surfaces, the method comprising:
recording raw image data of the surface using a polarimeter with pixelated polarizer array architecture and obtaining polarized images;
reducing glare in the polarized images to form enhanced contrast images;
detecting persons or objects behind the surface from the enhanced contrast images.

2. The method of claim 1, where the object is a human and the surface is the windshield or window of an automobile.

3. The method of claim 1, further comprising displaying the enhanced contrast images to a user.

4. The method of claim 1, further comprising annunciating a detected person to a user.

5. The method of claim 1, using a human face detected as input to a facial recognition system.

6. The method of claim 1, further comprising mounting the polarimeter on a pole or in a car.

7. The method of claim 1, wherein the polarimeter is handheld and operated by a user from a side of a road.

8. The method of claim 1, further comprising employing an external source of illumination.

9. The method of claim 8, wherein a polarization state of the external illumination is optimized to further reduce glare.

10. The method of claim 1, wherein the surface is water.

11. The method of claim 1, wherein the step of reducing glare in the polarized images to form enhanced contrast images comprises selecting an optimal pixel from within a super pixel of polarizing filters and displaying the optimal pixels.

12. The method of claim 11, wherein the step of selecting an optimal pixel from within a super pixel of polarizing filters comprises determining which individual pixel within the super pixel has the lowest value, and selecting that pixel value for display.

13. The method of claim 12, wherein the step of selecting an optimal pixel from within a super pixel of polarizing filters further comprises repeating, for every super pixel in a region of interest, the steps of selecting an optimal pixel from within a super pixel of polarizing filters, determining which individual pixel within the super pixel has the lowest value, and selecting that pixel value for display.

14. The method of claim 11, where a super pixel comprises four pixels, the four pixels polarized at 0, 45, 90, and 135 degrees, respectively.

15. The method of claim 11, where the pixels in the pixelated polarizer array are oriented at −20, −10, 0, 10, and 20 degrees.

16. The method of claim 1, wherein the step of reducing glare in the polarized images to form enhanced contrast images comprises computing an image comprising a weighted sum of reported intensities from a super-pixel that minimizes glare,
reducing glare in the polarized images.

17. The method of claim 16, further comprising determining the optimal angle of polarization to reduce glare as the angle orthogonal to the angle of polarization reported for each pixel of the polarimeter.

18. The method of claim 16, wherein a rotating retarder is placed in front of the PPA and rotated to optimally minimize glare.

19. The method of claim 18, wherein the rotating retarder is dynamically positioned.
